(19) United States
(12) Patent Application Publication
(10) Pub. No.: US 2025/0144560 A1
(43) Pub. Date: May 8, 2025

(54) Heat Driven Osmosis Water and Power Generator

(71) Applicant: Lonnie G. Johnson, Atlanta, GA (US)

(72) Inventor: Lonnie G. Johnson, Atlanta, GA (US)

(21) Appl. No.: 18/938,606

(22) Filed: Nov. 6, 2024

Related U.S. Application Data
(60) Provisional application No. 63/547,625, filed on Nov. 7, 2023.

(51) Int. Cl. B01D 53/26; B01D 5/00; B01D 53/14; B01D 53/18; B01D 61/00; E03B 3/28; F03B 13/08

(52) U.S. Cl. CPC B01D 53/263; B01D 5/006; B01D 53/1425; B01D 53/18; B01D 61/0022; E03B 3/28; F03B 13/08; B01D 2257/80; B01D 2313/243; B01D 2313/246; F05B 2220/706

(57) ABSTRACT

An atmospheric water vapor extraction power generation device includes a dilute hygroscopic solution flow loop, air humidity exchanger, condensation solution circulation pump, pressure retarded osmosis exchanger, pressure exchanger, evaporation chamber, recuperative heat exchanger, concentrated solution circulation pump, solution pressure differential turbine generator, freshwater power turbine, concentrated hygroscopic solution flow loop and condensed water reservoir.

### CROSS-REFERENCE TO RELATED APPLICATIONS

Applicant claims the benefit of U.S. Provisional Patent Application Ser. No. 63/547,625 filed Nov. 7, 2023 and entitled “Heat Driven Osmosis Water And Power Generator”.

### SUMMARY OF THE INVENTION

The present invention uses a hygroscopic solution to condense atmospheric water in combination with a heat driven distillation process to extract the water from the solution and a pressure retarded osmosis power generation. There are numerous applications where an inexpensive device that extracts water from the ambient atmosphere would be useful. Applications range from supplying power and water for farm irrigation, power and freshwater in geographically remote locations where power and freshwater is scarce, to reducing the grid load of buildings for HVAC and other applications. The heat to drive the process may be provided from a range of sources depending on the application including geothermal, solar or waste heat such as that released by industrial processes. For large scale production of drinking water in arid climates or supplying dry air to buildings, solar could be an attractive heat source. On the other hand, waste heat from cooking stoves could be used for production of water in smaller scale applications such as watering household flower plants or building dehumidification.

### FIELD OF THE INVENTION

The present invention relates, in general, to an improved power generator and ambient water condenser device, system and method. More specifically, the present invention relates to improved power generation and ambient humidity condenser apparatuses, assemblies, methods, and systems having components operative in an enclosed environment wherein all components are placed in an enclosed space configured to provide potable water extracted from ambient air.

### BACKGROUND OF THE INVENTION

Although the Earth's surface is approximately seventy-one percent water, over ninety-five percent of this water is found in oceans making it non-potable. The remaining approximately fifteen percent of the Earth's water exists as water vapor, in rivers, in lakes, in icecaps, in glaciers, in ground water, and in aquifers. With the Earth's population exceeding seven billion people, there is an increasing need to provide sources of fresh potable water, especially in arid climates and underdeveloped areas with limited access to water. In addition, there exist a need to transition to reduce dependance on fossil fuels for power generation and transportation.

Atmospheric humidity condensers utilizing are a known art for extracting water from the ambient atmosphere. However, many of these systems are expensive requiring bulky inefficient components operating in sizable water condensation systems. The predominant process for extracting water from ambient air is by use of electrical energy driven refrigeration cycles which consume very large amounts of energy. Other solutions include water desalination systems for harvesting water from ocean or sea salt water and fog harvesters that are used specialized membranes to collect potable water ambient air. In general, these solutions are quite cumbersome, inefficient, and expensive as well. None of them produce electricity during the condensation process.

Accordingly, there remains a need for improved, efficient, inexpensive atmospheric water extraction system that generates electrical power at the same time. This need and other needs are satisfied by the various aspects of the present disclosure.

### BRIEF DESCRIPTION AND PREFERRED EMBODIMENT

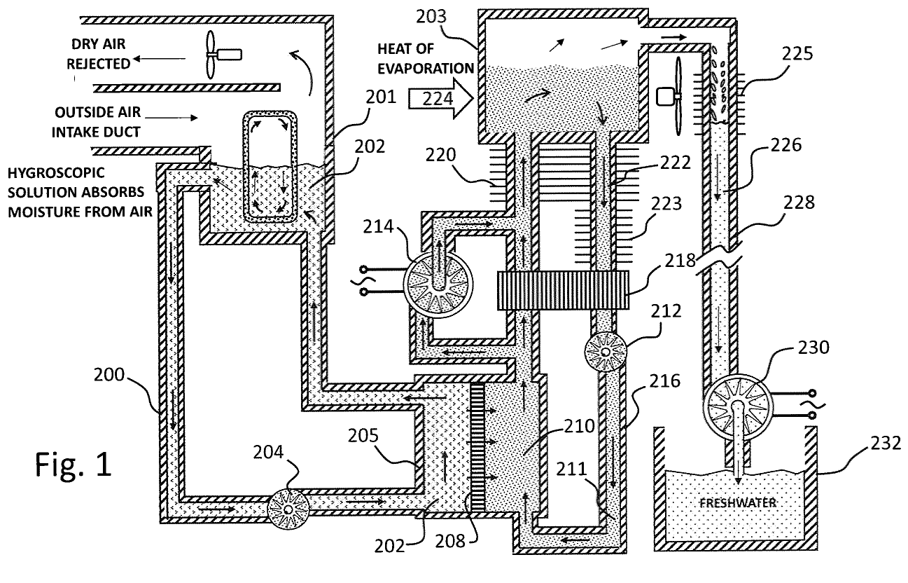

FIG. 1 is a schematic view of the atmospheric water vapor extraction power generation device embodying principles of the invention in a preferred form.

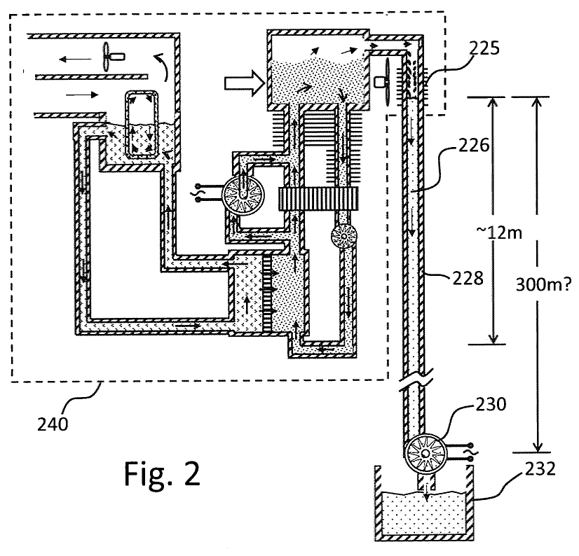

FIG. 2 is a schematic view of the atmospheric water vapor extraction power generation device embodying principles of the invention in another preferred form.

### DETAILED DESCRIPTION AND PREFERRED EMBODIMENT

FIG. 1 shows an atmospheric water vapor extraction power generation device that is representative of the present invention. The basic device consists of dilute hygroscopic solution flow loop 200, air humidity exchanger 201, condensation solution circulation pump 204, pressure retarded osmosis exchanger 205, pressure exchanger 218, evaporation chamber 203, recuperative heat exchanger 220, concentrated solution circulation pump 212, solution pressure differential turbine generator 214, freshwater power turbine 230, concentrated hygroscopic solution flow loop 216 and condensed water reservoir 232.

Pump 204 circulates dilute hygroscopic solution 202 between air humidity exchanger 201 and osmosis exchanger 205. Moisture is absorbed into hygroscopic solution 202 from air circulation through humidity exchanger 201. On the other hand, as solution 202 circulates through osmosis exchanger 205, moisture is extracted through osmosis membrane 208 by concentrated hygroscopic solution 210. Concentrated hygroscopic solution circulation pump 212 circulates concentrated solution between pressure retarded osmosis exchanger 205 and vaporization chamber 203. Solution flowing to and from vaporization chamber 203 is maintained at a lower pressure than fluid circulating through osmosis exchanger 205. Pressure exchanger 218 and turbine 214 are driven by the pressure difference. Concentrated solution circulation pump 212 circulates solution between osmosis chamber 205 and evaporation chamber 203. Pump 212 also compensates for efficiency losses associated with pressure exchanger 218 to maintain a stable pressure differential. Solution 210 leaving osmosis exchanger 205 passes through pressure exchanger 218 and bypass generator 214 and on into evaporation chamber 203. Heat 224 is coupled to evaporation chamber 203 to evaporate water out of solution passing through chamber 203. The resulting steam is condensed by heat rejection by heat exchanger 225 to ambient with the resulting condensed water 226 being supplied through vertical column conduit 228 to freshwater power turbine 230 and then on into reservoir 232. With evaporation of water therefrom, solution leaves chamber 203 more concentrated. It passes through pressure exchanger 208 and on to pump 212. Heat exchanger 223 cools solution 222 returning to osmosis exchanger 205 to further reduce its water vapor pressure in preparation for absorption of additional water. Conduit couples concentrated solution flow from pump 212 to osmosis exchanger 205.

Electrical power and water are continuously produced as water is condensed from air passing through chamber 201 into solution 202 and extracted from solution 202 as it circulates through exchanger 205. Pressurized concentrated solution passing through exchanger 205 increases in volume as it extracts water from solution 202 through osmosis membrane 208. The increased volume leaving exchanger 205 passes through pressure exchanger 218 and turbine generator 214. The volume of fluid flowing through pressure exchanger 218 is equivalent to the volume leaving vaporization chamber 203 and thereby has sufficient energy to substantially repressurize the fluid leaving the vaporization chamber. The excess volume of solution resulting from water absorption through membrane 208 from solution 202 is supplied to turbine 214 to generate electricity from the pressure difference between fluid 210 in chamber 205 and the lower pressure solution in chamber 203.

FIG. 2 shows a representative embodiment of the invention wherein the main sections 240 of the invention are mounted at some significant height above fresh water electrical generator turbine 214. In this representative example, freshwater generator 214 is mounted 300 meters lower, a representative substantial height difference. Water condensed at the top of vertical column conduit 228 is supplied to water turbine 230 at the bottom under gravitational pressure head of water 226. The efficiency of such a system is not limited to Carnot because the water within the column is extracted from the atmosphere at height and therefore does not have to be considered in the efficiency calculation. The ambient air, solar, does the work in carrying the water to the top of the converter. The efficiency relative to Carnot is determined from the amount of heat input and its temperature relative to the amount of electrical power generated by turbine 214. Turbine 230 is not within the basic thermodynamic cycle.

As such, the electric power and freshwater generation includes a dilute hygroscopic solution, a concentrated hygroscopic solution, an osmosis exchanger, an air humidity exchanger, a pressure exchange turbine generator, an evaporation chamber, and a concentrated solution circulation pump, wherein the dilute hygroscopic solution is circulating between the air humidity exchanger and the osmosis exchanger extracting moisture from ambient air and supplying the moisture to the osmosis exchanger, the concentrated hygroscopic solution circulating between the osmosis exchanger and the evaporation chamber absorbing solution by osmosis in the osmosis exchanger and releases the solution in the evaporation chamber, and wherein the concentrated solution pump receiving water depleted solution leaving the evaporation chamber and supplying the solution through the osmosis exchanger to the pressure turbine at high pressure, the concentrated solution having a higher absorption affinity for moisture absorbs water from the low concentration solution by osmosis as it passes through the osmosis exchanger and thereby brings the absorbed water to the high pressure of the concentrated solution as supplied by the concentrated solution pump, at substantially the same pressure, the increased volume of solution flow to turbine generator relative to that supplied by the concentrated solution pump results in a greater amount of power being generated by the pressure turbine than that consumed by the concentrated solution pump resulting in net output power.

The electric power and freshwater generation has an evaporation chamber, a humidity exchanger, a freshwater column having vertical height with a top end and bottom end, a freshwater electrical generator, a humidity exchange chamber, a supply of hygroscopic solution, wherein the evaporation chamber, the humidity exchange chamber, water column and the electrical generator are fluidically coupled together the, the hygroscopic solution being contained within the evaporation chamber and humidity exchange chamber and circulating between the evaporation chamber and the humidity exchange chamber, the humidity exchange chamber exposing the hygroscopic solution to ambient air to facilitate attraction and condensation of ambient humidity into the hygroscopic solution, the resulting water latent solution carrying the absorbed water to the evaporation chamber wherein heat is supplied to evaporate water therefrom, the evaporated water flowing to the top end of the water column where heat is removed to condense the water, the fresh water electrical generator being connected to the bottom of the freshwater column, the flows condensed water flowing under the pressure resulting from the weight of the water column through the electrical generator to produce electricity.

I claim:

1. An electric power and freshwater generation comprising:
a dilute hygroscopic solution;
a concentrated hygroscopic solution;
an osmosis exchanger;
an air humidity exchanger;
a pressure exchange turbine generator;
an evaporation chamber, and
a concentrated solution circulation pump,
wherein the dilute hygroscopic solution is circulating between the air humidity exchanger and the osmosis exchanger extracting moisture from ambient air and supplying the moisture to the osmosis exchanger, the concentrated hygroscopic solution circulating between the osmosis exchanger and the evaporation chamber absorbing solution by osmosis in the osmosis exchanger and releases the solution in the evaporation chamber,
wherein the concentrated solution pump receiving water depleted solution leaving the evaporation chamber and supplying the solution through the osmosis exchanger to the pressure turbine at high pressure, the concentrated solution having a higher absorption affinity for moisture absorbs water from the low concentration solution by osmosis as it passes through the osmosis exchanger and thereby brings the absorbed water to the high pressure of the concentrated solution as supplied by the concentrated solution pump, at substantially the same pressure, the increased volume of solution flow to turbine generator relative to that supplied by the concentrated solution pump results in a greater amount of power being generated by the pressure turbine than that consumed by the concentrated solution pump resulting in net output power.

2. The electric power and freshwater generator as disclosed in claim 1 further including a pressure exchanger, the pressure exchanger being fluidly coupled between the osmosis exchanger and the evaporation chamber in parallel with the pressure exchange turbine and in series with the concentrated solution circulation pump whereby the volume flowing through the pressure turbine is substantially equivalent to the volume of water absorbed by the concentrated solution within the osmosis exchanger, and the volume flowing through the pressure exchanger is substantially equivalent to that pumped by concentrated solution circulation pump, the pressure exchanger recovering the pressure energy of solution leaving the osmosis exchanger passing therethrough from high pressure to low pressure and supplying the pressure energy to low pressure solution passing therethrough from the evaporation chamber to supply it at high pressure to the concentrated solution circulation pump.

3. The electric power and freshwater generator as disclosed in claim 1 further includes a freshwater turbine and wherein the vaporization chamber includes a heat sink for removing heat to condense the water vapor generated therein, the resulting condensed water being supplied under pressure to the freshwater turbine whereby the freshwater turbine generates electrical power.

4. The electric power and freshwater generator as disclosed in claim 1 further includes a water collection reservoir, water condensed in the evaporation chamber being supplied to the water collection reservoir.

5. An electric power and freshwater generation comprising:
an evaporation chamber;
a humidity exchanger;
a freshwater column having vertical height with a top end and bottom end;
a freshwater electrical generator;
a humidity exchange chamber;
a supply of hygroscopic solution,
wherein the evaporation chamber, the humidity exchange chamber, water column and the electrical generator are fluidically coupled together the, the hygroscopic solution being contained within the evaporation chamber and humidity exchange chamber and circulating between the evaporation chamber and the humidity exchange chamber, the humidity exchange chamber exposing the hygroscopic solution to ambient air to facilitate attraction and condensation of ambient humidity into the hygroscopic solution, the resulting water latent solution carrying the absorbed water to the evaporation chamber wherein heat is supplied to evaporate water therefrom, the evaporated water flowing to the top end of the water column where heat is removed to condense the water, the fresh water electrical generator being connected to the bottom of the freshwater column, the flows condensed water flowing under the pressure resulting from the weight of the water column through the electrical generator to produce electricity.
